(19) United States
(12) Patent Application Publication
(10) Pub. No.: US 2010/0333162 A1
(43) Pub. Date: Dec. 30, 2010

(54) System and Method to Provide an Extensible Storefront

(75) Inventors: Heather Lloyd, Croton Falls, NY (US); Daniel Malee, Wheaton, IL (US); Satish Baratam, Croton Falls, IL (US); Charles Boland, Oak Park, IL (US); Mark Kashevaroff, Daly City, CA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., Reno, NV (US)

(21) Appl. No.: 12/490,537

(22) Filed: Jun. 24, 2009

(51) Int. Cl. H04N 7/173; G06F 17/30

(52) U.S. Cl. 725/131; 707/769; 707/759; 707/957

(57) ABSTRACT

A computer implemented method includes receiving a search query at a computing device of a private media delivery network. After receiving the search query, the computer implemented method includes performing a first search with respect to first content available from a first platform within the private media delivery network and performing a second search with respect to second content available from a second platform that is external to the private media delivery network. The computer implemented method includes sending search results for display at a display device. The search results are based on the first search and based on the second search.

### FIELD OF THE DISCLOSURE

The present disclosure is generally related to providing an extensible storefront.

### BACKGROUND

When deploying a network, such as an Internet Protocol Television (IPTV) network, a manufacturer of certain network equipment may provide software for creating a storefront. The software may constrain the storefront to offering a fixed, inextensible catalog of items. For example, the software for creating a storefront in an IPTV network may constrain the storefront to offering a limited set of items that can be delivered via the IPTV network. Such constraints on the capabilities of the storefront may restrict a network provider from using the storefront to offer a wide range of products and services.

### BRIEF DESCRIPTION OF THE DRAWINGS

FIG. 1 is a block diagram of a first particular embodiment of a system to provide an extensible storefront;

FIG. 2 is a block diagram of a second particular embodiment of a system to provide an extensible storefront;

FIG. 3 is a block diagram of a third particular embodiment of a system to provide an extensible storefront;

FIG. 4 is a block diagram of a fourth particular embodiment of a system to provide an extensible storefront;

FIG. 5 is a block diagram of a particular embodiment of a search interface;

FIG. 6 is a flow diagram of a first particular embodiment of a method to provide an extensible storefront;

FIG. 7 is a flow diagram of a second particular embodiment of a method to provide an extensible storefront;

FIG. 8 is a block diagram of an illustrative embodiment of an Internet Protocol Television (IPTV) system; and

FIG. 9 is a block diagram of an illustrative embodiment of a general computer system.

### DETAILED DESCRIPTION

The various embodiments disclose a unified storefront of an electronic commerce platform that enables browsing, sampling, purchasing, and consumption of heterogeneous content over a private media content delivery network via a variety of devices. For example, the electronic commerce platform may be accessed via a set-top box device, a computing device, a wireless device, or other types of devices. The unified storefront may augment an electronic commerce platform for use with the private media content delivery network. For example, the unified storefront may enable seamless access to catalogs from a service provider of the private media content delivery network and to catalogs external to the private media content delivery network. To illustrate, the unified storefront may enable access to a catalog of video-on-demand content offered by an Internet Protocol Television (IPTV) network service provider and may also offer access to a catalog of posters, t-shirts, and baseball caps associated with the video-on-demand content that is offered by a third party that is external to the IPTV network. By offering access to an extensible catalog, the united storefront enables a service provider of a private media content delivery network to offer convenient one-stop shopping for subscribers.

In a particular embodiment, a computer implemented method includes receiving a search query at a computing device of a private media delivery network. After receiving the search query, the computer implemented method includes performing a first search with respect to first content available from a first platform within the private media delivery network and performing a second search with respect to second content available from a second platform that is external to the private media delivery network. The computer implemented method includes sending search results for display at a display device. The search results are based on the first search and based on the second search.

In another particular embodiment, a set-top box device includes a computer-readable storage medium includes operational instructions that, when executed by a processor, cause the set-top box device to receive a search query from a remote control device. The computer-readable storage medium includes operational instructions that, when further executed by the processor, cause the set-top box device to send the search query from the set-top box device to a storefront server of a private media delivery network. The storefront server is capable of searching an extensible catalog. The extensible catalog is extensible by adding one or more new catalogs that are searchable via the search query. The computer-readable storage medium includes operational instructions that, when further executed by the processor, cause the set-top box device to receive search results from the storefront server. The search results include information identifying content from a plurality of content sources of the extensible catalog. At least some of the information identifying the content originates from a content source that is external to the private media content delivery network.

In another particular embodiment, a computer system includes a search engine interface to receive a search request and to output search results via a private media content delivery network. The computer system includes a searchable database responsive to the search engine interface. The searchable database includes memory to store a plurality of catalogs. Each catalog includes information identifying downloadable items and information identifying physical items available for purchase. The searchable database is searchable in response to receiving the search request to provide the search results. At least one catalog of the plurality of catalogs is external to the private media content delivery network. The computer system includes catalog extension logic to selectively extend the catalog by adding one or more catalogs to the searchable database.

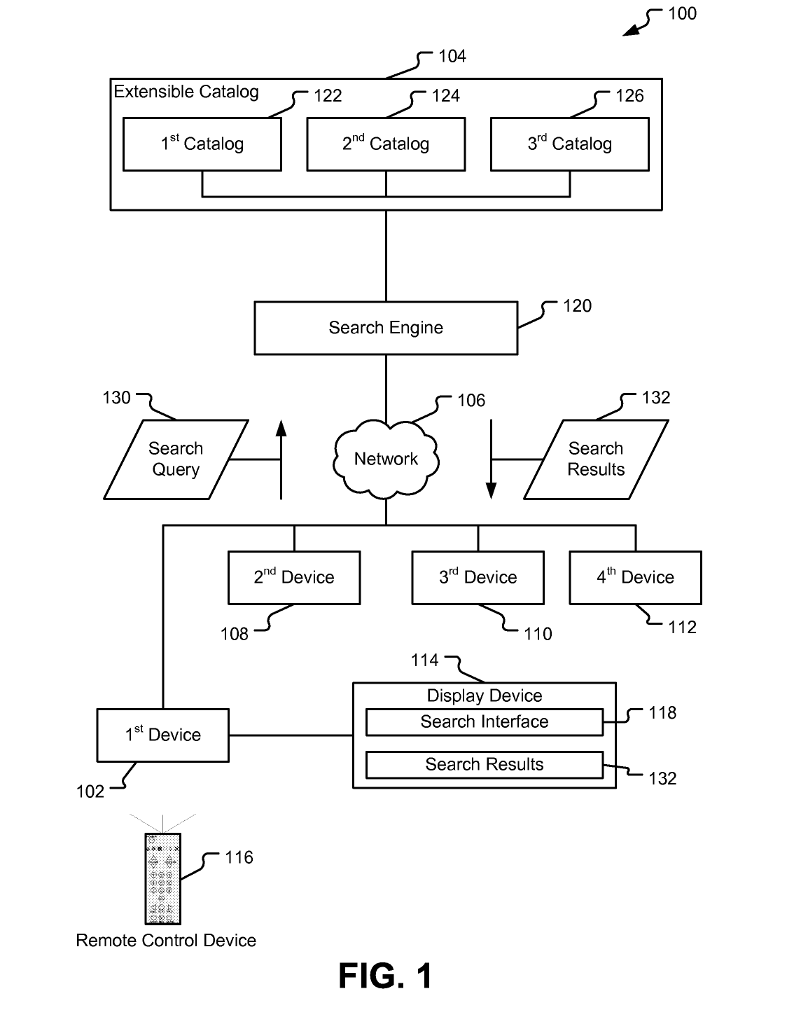

Referring to FIG. 1, a block diagram of a first particular embodiment of a system to provide an extensible storefront is depicted and generally designated 100. In the system 100, a first device 102, a second device 108, a third device 110, and a fourth device 112 are coupled to a search engine 120 via a network 106. The search engine 120 is coupled to an extensible catalog 104 that includes a first catalog 122, a second catalog 124, and a third catalog 126.

A remote control device 116 may be used to interact with the first device 102. A display device 114 is coupled to the first device 102. The display device 114 may be separate from the first device 102 or may be integrated with the first device 102.

Each of the devices 102, 108, 110, and 112 may be a set-top box device, a personal computing device, a mobile computing device, another computing device, or any combination thereof. The first device 102 may display a search interface 118 at the display device 114. The first device 102 may receive input at the search interface 118 from the remote control device 116 and may send a search query 130 to the search engine 120. In response to sending the search query 130, the first device 102 may receive search results 132 from the search engine 120 and may display the search results 132 at the display device 114. For example, the remote control device 116 may be used to create the search query 130 to search for items related to a television program or movie. The search results 132 may identify video-on-demand content, video files, and tangible goods available for purchase that are related to the television program or movie. The first device 102 may be operable to purchase one or more items from the extensible catalog 104 that are displayed in the search results 132. In a particular embodiment, when a purchased item is an electronically downloadable item, the purchase may be made at the first device 102 and the purchased item may be downloaded at another device associated with the purchaser, such as the second device 108, the third device 110, or the fourth device 112. The search engine 120 may receive the search query 130 from the first device 102, search the extensible catalog 104 based on the search query 130, and send the search results 132 to the first device 102.

The extensible catalog 104 may include various catalogs, such as the catalogs 122, 124, and 126. The catalogs 122, 124, and 126 may include information identifying items available for purchase, such as electronically downloadable items and tangible items. The electronically downloadable items may include video-on-demand content, ringtones, video files, audio files, other electronically downloadable files, or any combination thereof. The tangible items may include clothing items, memorabilia, and other tangible items. For example, when the first device 102 is a set-top box device, the search results 132 may include items that are associated with a television program or movie available for viewing at the first device 102. The extensible catalog 104 may include multiple catalogs of items for sale. For example, the extensible catalog may include information identifying video-on-demand content, over-the-top content, video files, audio files, ring tones, and other types of content. Over-the-top content is content that is offered by a third party over a service provider network. For example, a city may offer videos of city council meetings over a service provider network. The extensible catalog 104 may be extended by adding additional catalogs to the extensible catalog 104. The catalogs 122, 124, and 126 may be updated by replacing one or more of the catalogs 122, 124, and 126 with an updated catalog. At least one of the catalogs 122, 124, and 126 may be part of a private media content delivery network and the other catalogs may be external to the private media content delivery network. For example, the first catalog 122 may include information identifying content available for delivery via the private media content delivery network, such as video-on-demand content. The second catalog 124 may be provided by a third party that is different from the private media content delivery network. For example, the second catalog 124 may include information identifying tee shirts, baseball caps, posters, and other tangible goods that are available for purchase and that are related to content delivered via the network 106. For example, when the first device 102 is a set-top box device, a user may search the extensible catalog 104 using a title of a television program or a movie and receive the search results 132 that include information identifying items available for purchase in the extensible catalog 104.

In operation, the first device 102 displays the search interface 118 at the display device 114. The remote control device 116 may be used to input the search query 130 and to instruct the first device 102 to send the search query 130 to the search engine 120. The search engine 120 may receive the search query 130 and search the extensible catalog 104. The search engine 120 may return the search results 132 to the first device 102 for display at the display device 114. One or more items from the search results 132 may be selected for purchase using the remote control device 116.

Thus, by providing the extensible catalog 104, a service provider can provide third party content via the extensible catalog 104. The extensible catalog 104 is not constrained to items that can be delivered via the network 106. For example, the extensible catalog 104 may include information identifying tangible items that may be physically delivered to a home of a purchaser.

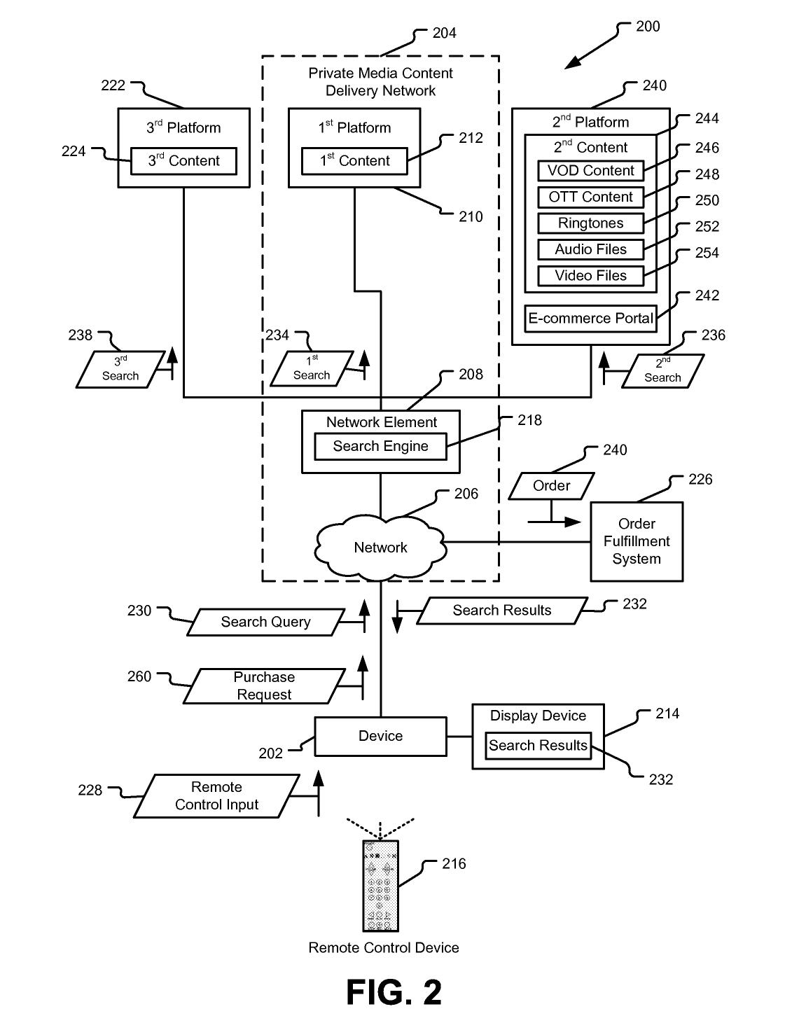

Referring to FIG. 2, a block diagram of a second particular embodiment of a system to provide an extensible storefront is depicted and generally designated 200. The system 200 includes a device 202 coupled to a private media content delivery network 204 via a network 206. A display device 214 is coupled to the device 202. An order fulfillment system 226 is coupled to the network 206.

The private media content delivery network 204 is capable of delivering media content, such as video content and audio content, to the device 202. In a particular embodiment, the private media content delivery network 204 is an IPTV network and the device 202 is a set-top box device. The private media content delivery network 204 includes the network 206, a network element 208, and a first platform 210. A second platform 240 may be coupled to the network element 208, where the first platform 210 is part of the private media content delivery network 204 and where the second platform 240 is external to the private media content delivery network 204. A search engine 218 may be used to search first content 212 hosted at the first platform 210 and to search the second content 244 hosted at the second platform 240. The first content 212 and the second content 244 may be part of an extensible catalog of items that the search engine 218 searches. A third platform 222 that includes third content 224 may be added to the extensible catalog of items searched by the search engine 218. For example, the search engine 218 may initially search the first platform 210 and the second platform 240. A provider of the private media content delivery network 204 may extend a catalog of items offered for sale by adding the third platform 222 to the platforms 210 and 240 that are searched by the search engine 218. In a particular embodiment, the platforms 210, 222, and 240 are hardware computing devices running specialized software for providing content that includes a catalog containing information identifying items available for purchase.

The device 202 may receive remote control input 228 via a remote control device 216. The device 202 may be a set-top box device, a computing device, a mobile computing device, another computing device, or any combination thereof. The device 202 may display media content received from the private media content delivery network 204 at the display device 214.

The network element 208 may include a computing device that hosts a search engine 218. The search engine 218 may receive a search query 230 from the device 202 to search platforms 210, 240, and 222. The search engine 218 may perform a search of the platforms 210, 240, and 222, and may return search results 232 to the device 202 for display at the display device 214. The first platform 210 includes first content 212, the second platform 240 includes second content 244, and the third platform 222 includes third content 224. For example, the second content 244 may include one or more of video-on-demand content 246, over-the-top content 248, ring tones 250, audio files 252, and video files 254. The second platform 240 may include an e-commerce portal 242. Each of the first content 212, second content 244, and third content 224 may include information identifying content available for purchase at the device 202. For example, the contents 212, 244, and 224 available for purchase at the device 202 may include information identifying electronically downloadable media content and information identifying tangible goods.

In a particular embodiment, the second content 244 includes information identifying electronically downloadable content, such as video-on-demand content 246, ring tones 250, audio files 252, and video files 254. For example, the video-on-demand content 246 may be downloadable to a set-top box device, a computing device, or a mobile computing device. The ring tones 250 may be downloadable to a mobile telephone device. The audio files 252 may include compressed audio files capable of being downloaded to an electronic device that includes a music player. The video files 254 may include compressed video files capable to being downloaded to a video player. The first content 212, the second content 244, and the third content 224 may include information identifying at least one tangible product available for purchase, such as a t-shirt, a baseball cap, or a poster.

In operation, the device 202 may receive the remote control input 228 via the remote control device 216. In response to receiving the remote control input 228, the device 202 may send the search query 230 to the search engine 218. The search engine 218 may perform a first search 234 of the first content 212, a second search 236 of the second content 244, and a third search 238 of the third content 224. After performing at least one of the searches 234, 236, and 238, the search engine 218 may send the search results 232 to the device 202. The device 202 may receive the search results 232 and display the search results 232 at the display device 214. The remote control device 216 may be used to select one or more items from the search results 232 for purchase and to send a purchase request 260 to the network element 208. When the purchased item is an electronically downloadable item, the search engine 218 may instruct the e-commerce portal 242 to make the electronically downloadable content available for download by the device 202. In a particular embodiment, the purchase request 260 may include a request to purchase at least one tangible item. When the purchased item is a tangible item, the search engine 218 may send an order 240 to an order fulfillment system 226 to fulfill the order for the tangible item. The search engine 218 may receive the purchase request 260 and send the order 240 to the order fulfillment system 226. The order fulfillment system 226 may initiate shipment of a purchased tangible item to a purchaser.

Thus, the private media content delivery network 204 can provide an extensible catalog to which additional content, such as the second content 244 and the third content 224, can be made available for purchase by the device 202. In this way, a provider of the private media content delivery network 204 can provide various types of content for purchase via the extensible catalog, including content available for purchase from third parties.

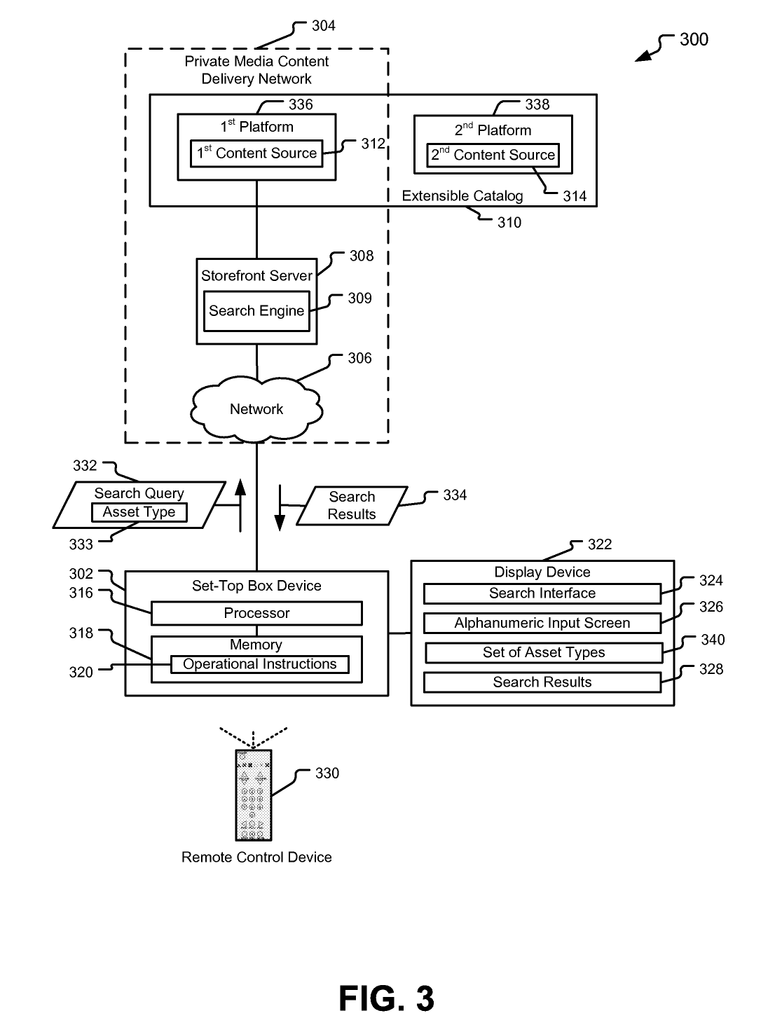

Referring to FIG. 3, a block diagram of a third particular embodiment of a system to provide an extensible storefront is depicted and generally designated 300. The system 300 includes a set-top box device 302 coupled to a private media content delivery network 304. The private media content delivery network 304 includes a network 306, a storefront server 308, and an extensible catalog 310. A display device 322 is coupled to the set-top box device 302. For example, the display device may be a Liquid Crystal Display (LCD) display device, a plasma display device, a Digital Light Processing (DLP) display device, a Cathode Ray Tube (CRT) display device, other display device, or any combination thereof. The storefront server 308 may be a hardware computing device that is running specialized software, such as electronic commerce software.

The private media content delivery network 304 may be an Internet Protocol Television (IPTV) based network that provides media content, such as video content and audio content, to the set-top box device 302. The extensible catalog 310 may include a first content source 312 provided by a first platform 336 and a second content source 314 provided by a second platform 338. The first content source 312 may include information identifying electronically downloadable content and the second content source 314 may include information identifying tangible products available for purchase. The first platform 336 may include a computing device that is part of the private media content delivery network 304. The second platform 338 may be external to the private media content delivery network 304. The storefront server 308 may include a computing device that provides a search engine 309 for searching the extensible catalog 310.

The set-top box device 302 may include a processor 316 and a memory 318. The memory 318 may include operational instructions 320. The set-top box device 302 may display a search interface 324 at the display device 322. The search interface 324 may be associated with the search engine 309.

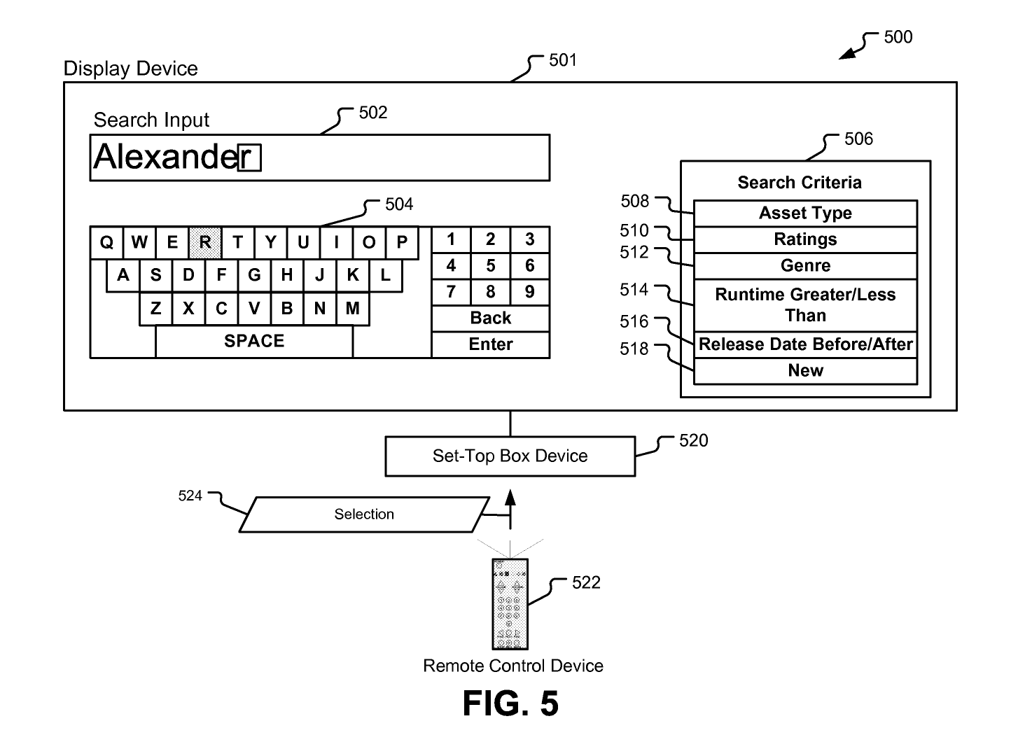

In operation, the set-top box device 302 may display an alpha-numeric input screen 326 at the display device 322. An example of the alpha-numeric input screen 326 is depicted in FIG. 5. The alpha-numeric input screen 326 may be used to facilitate input of a search query 332 via selections received from a remote control device 330. For example, the remote control device 330 may be used to select alpha-numeric characters from the alpha-numeric input screen 326 to create the search query 332. The alpha-numeric input screen 326 may enable selection of an asset type from a set of asset types 340 displayed at the display device 322. For example, the set of asset types 340 may include one or more of a video-on-demand (VOD) asset type, an over-the-top (OTT) asset type, a ringtone asset type, an audio file asset type, a video file asset type, clothing asset type, poster asset type, another asset type, or any combination thereof. The search query 332 may include information identifying the selected asset type 333.

The set-top box device 302 may send the search query 332 to the search engine 309. In response to receiving the search query 332, the search engine 309 may search the extensible catalog 310 and send search results 334 to the set-top box device 302. The set-top box device 302 may receive the search results 334 and display the search results 334 at the display device 322. The search results 334 may include information identifying content from the first content source 312 and the second content source 314 of the extensible catalog 310. At least some of the content identified in the search results 334 may originate from the second content source 314 that is external to the private media content delivery network 304. The search results 334 may include information identifying assets from the extensible catalog 310 having the selected asset type 333. The search results 334 may present the information identifying content from the first content source 312 and the second content source 314 in a combined format. For example, the information identifying content from the first content source 312 and the second content source 314 may be intermingled and presented in a seamlessly integrated format.

By providing the extensible catalog 310 and enabling the search engine 309 to search the extensible catalog 310, a provider of the private media content delivery network 304 may enable subscribers to search the extensible catalog 310 for different types of content available for purchase. The provider of the private media content delivery network 304 can generate revenue from the sale of items in the extensible catalog 310 by offering items, such as tangible goods, that are not deliverable via the network 306.

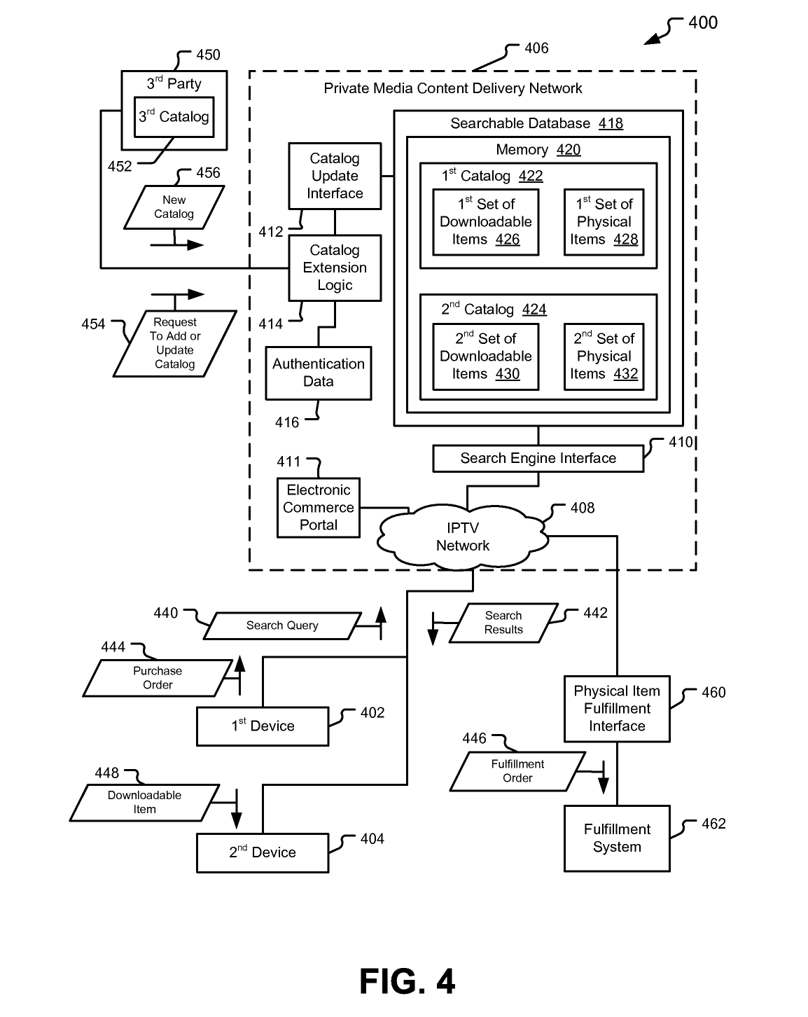

Referring to FIG. 4, a block diagram of a fourth particular embodiment of a system to provide an extensible storefront is depicted and generally designated 400. The system 400 includes a first device 402 and second device 404 coupled to a private media content delivery network 406 via an Internet Protocol Television (IPTV) network 408. The private media content delivery network 406 includes a search engine interface 410, an electronic commerce portal 411, a catalog update interface 412, catalog extension logic 414, authentication data 416, and a searchable database 418. The search engine interface 410, the catalog update interface 412, the catalog extension logic 414, the authentication data 416, and the searchable database 418 may each be hosted by a hardware computing device. The catalog update interface 412 and the catalog extension logic 414 may be operational instructions that are executable by a processor of a hardware computing device. The searchable database 418 includes a memory 420. The memory 420 includes a first catalog 422 and a second catalog 424. The first catalog 422 includes information identifying a first set of downloadable items 426 and information identifying a first set of physical items 428. The second catalog 424 includes information identifying a second set of downloadable items 430, and information identifying a second set of physical items 432.

The catalog extension logic 414 may enable selectively extending the searchable database 418 by adding a catalog to the searchable database 418 or by updating at least one of the first catalog 422 and the second catalog 424. For example, a third catalog 452 from a third party 450 may be added to the searchable database 418 by sending a new catalog 456 to the catalog extension logic 414. In a particular embodiment, the catalog extension logic 414, after receiving the new catalog 456, authenticates whether the catalog may be added using the authentication data 416. For example, the catalog extension logic 414 may use the authentication data 416 to determine whether the third party 450 is authorized to update a catalog in the searchable database 418. The catalog update interface 412 may be used to update one of the catalogs 422 and 424 in the memory 420. For example, when the third catalog 452 has been added to the memory 420, the third party 450 may send a request to add or update the catalog 454 to the catalog update interface 412. The third party 450 may be a hardware computing device running specialized software.

In operation, the first device 402 may send a search query 440 to the search engine interface 410. The search engine interface 410 may receive the search query 440 and perform a search of the searchable database 418 by searching the first catalog 422 and the second catalog 424. The search engine interface 410 may send search results 442 back to the first device 402. One or more items from the search results 442 may be selected for a purchase. The first device 402 may send a purchase order 444 to the electronic commerce portal 411. The purchase order 444 may indicate an offer to purchase one or more of the items displayed in the search results 442. The electronic commerce portal 411 may send the purchase order 444 to a physical item fulfillment interface 460. The physical item fulfillment interface 460 may generate a fulfillment order 446 and send the fulfillment order 446 to a fulfillment system 462. For example, the fulfillment order 446 may include an order to send a tangible item to a purchaser. An item from the downloadable items 426 and 430 may be purchased at the first device 402 and downloaded at the second device 404. For example, when the first device 402 is a set-top box device, when the second device 404 is a mobile telephone device, and when the purchase order 444 includes a purchase of a downloadable item, the downloadable item 448 may be downloaded to the second device 404.

Thus, the searchable database 418 may include an extensible catalog that may be expanded and updated by third parties, such as the third party 450. By allowing the third party 450 to add the third catalog 452 to the searchable database 418 and to update the third catalog 452 with the new catalog 456, a provider of the private media content delivery network 406 can provide an extensible catalog that can be searched via the searchable database 418. By providing an extensible catalog, the provider of the private media content delivery network 406 can offer various items for purchase, such as the downloadable items 426 and 430 and the physical items 428 and 432.

Referring to FIG. 5, a block diagram of a particular embodiment of a search interface is depicted and generally designated 500. The search interface depicted in FIG. 5 is an example of the search interface 118 in FIG. 1, the search interface 324 of FIG. 3, or the search engine interface 410 of FIG. 4.

The system 500 includes a display device 501 coupled to a set-top box 520. The set-top box device 520 is operable to receive a selection 524 from a remote control device 522. The display device 501 may display at least one of a search input 502, an alpha-numeric keypad 504, and search criteria 506. For example, the search input 503 may be created by using the remote control device 522 to select letters and numbers from the alpha-numeric keyboard 504. The search criteria 506 may be used to further refine the search input 502. For example, the search criteria 506 may be used to search for posters available for purchase related to a particular television program or movie.

The search criteria 506 may include an asset type 508, ratings 510, genre 512, run time greater/less than 514, release date before/after 516, and new 518. The asset type 508 may include one or more of a video-on-demand asset type, an audio content asset type, a video content asset type, a ring tone asset type, a tangible product asset type, another asset type, or any combination thereof. The ratings 510 may include ratings that indicate that a particular asset is suitable for general audiences, parental guidance is advised, parents are strongly cautioned, restricted, or other rating. The genre 512 may include family entertainment, science fiction, drama, action, comedy, and other genres. The run time greater/less than 514 may be used to identify assets having a running time greater than or less than a specified amount. For example, by specifying that a run time of an asset should be less than one hundred and twenty minutes, all assets having a run time of less than one hundred twenty minutes may be identified. The release date before/after 516 may be used to search for assets that were released before or after a particular date. For example, specifying a release date of Jan. 1, 2008 or after will search for all assets released on or after Jan. 1, 2008. The new 518 search criteria may be used to find newly added items to the extensible catalog. For example, by selecting new 518, all assets added to the catalog from the last time that this particular set-top box device 520 performed a search may be displayed.

In operation, the set-top box device 520 may display the alpha-numeric input screen 504 at the display device 501. The remote control device 522 may be used to provide the selection 524. The selection 524 may be used to populate the search input 502. The selection 524 may be used to select from the search criteria 506. By providing the alpha-numeric input screen 504 and the search criteria 506, the remote control device 522 can be used to interact with the set-top box device 520 to create searches for various types of assets. Thus, a subscriber associated with the set-top box device 520 can search for and purchase various types of assets.

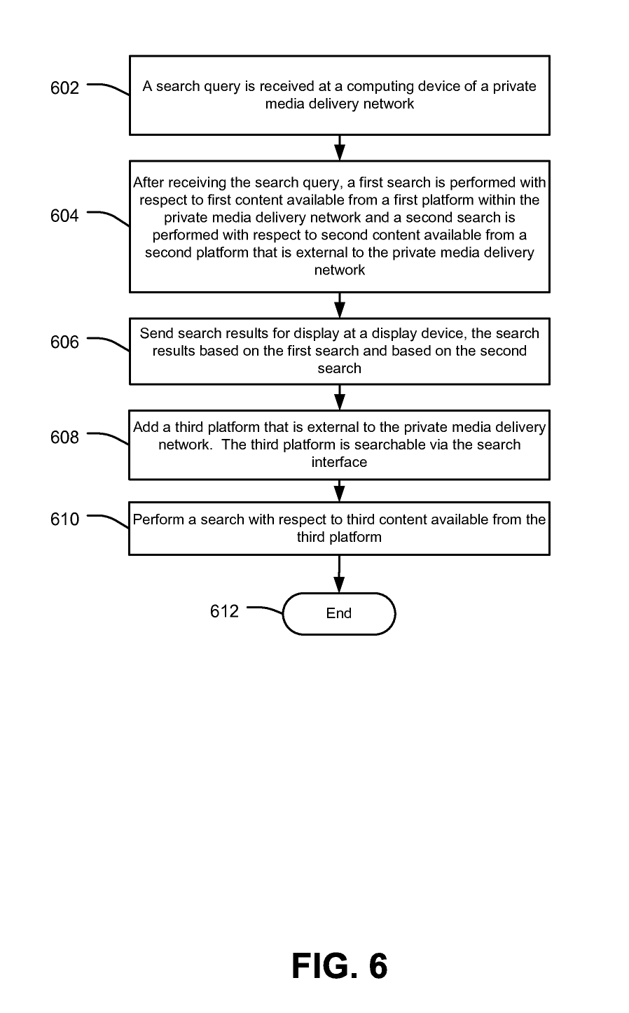

FIG. 6 is a flow diagram of a first particular embodiment of a method to provide an extensible storefront. The method may be performed by a computing device executing a search engine such as the search engine 120 in FIG. 1, the search engine 218 in FIG. 2, the search engine 340 in FIG. 3, or the search engine interface 410 in FIG. 4.

A computing device of a private media deliver network may receive a search query, at 602. Moving to 604, after receiving the search query, a first search may be performed with respect to first content available from a first platform within the private media content delivery network and a second search may be performed with respect to the second content available from a second platform that is external to the private media content delivery network. Continuing to 606, search results may be sent for display at a display device. The search results may be based on the first search and based on the second search. Advancing to 608, a third platform that is external to the private media content delivery network may be added. The third platform may be searchable via the search interface. Proceeding to 610, a search may be performed with respect to third content available from the third platform. The method ends at 612.

Thus, an extensible catalog may allow a search of first content available within a private media content delivery network and a search of second content external to the private media content delivery network. The extensible catalog may be extended by adding third content to the extensible catalog and enabling a user to search the first content, the second content, and the third content. In this way, a provider of the private media content delivery network can make items available for purchase and derive revenue from the sale of those items.

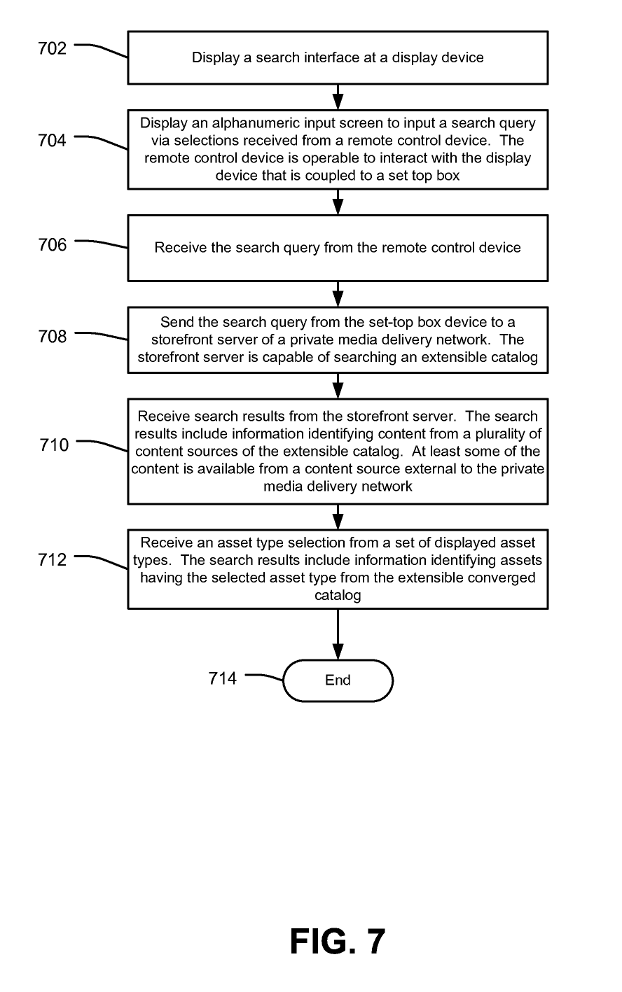

Referring to FIG. 7, a flow diagram of a second particular embodiment of a method to provide an extensible storefront is described. The method 702 may be performed by a device such as the first device 102 of FIG. 1, the second device 202 of FIG. 2, the set-top box device 302 of FIG. 3, or the first device 402 of FIG. 4.

A search interface may be displayed at a display device, at 702. Moving to 704, an alpha-numeric input screen may be displayed to input a search query via selections received from a remote control device. The remote control device may be operable to interact with the display device that is coupled to a set-top box device. Advancing to 706, the search query may be received from the remote control device. Proceeding to 708, the search query may be sent from the set-top box device to a storefront server of a private media delivery network. The storefront server may be capable of searching an extensible catalog. For example, the storefront server may be a hardware computing device running software capable of providing a network accessible storefront. Proceeding to 710, search results are received from the storefront server. The search results may include information identifying content from a plurality of content sources of the extensible catalog. At least some of the information of the search results may be available from a content source external to the private media content delivery network. Advancing to 712, an asset type selection may be received from a set of displayed asset types. The search results may include information identifying assets having the selected asset type from the extensible converged catalog. The method then ends at 714.

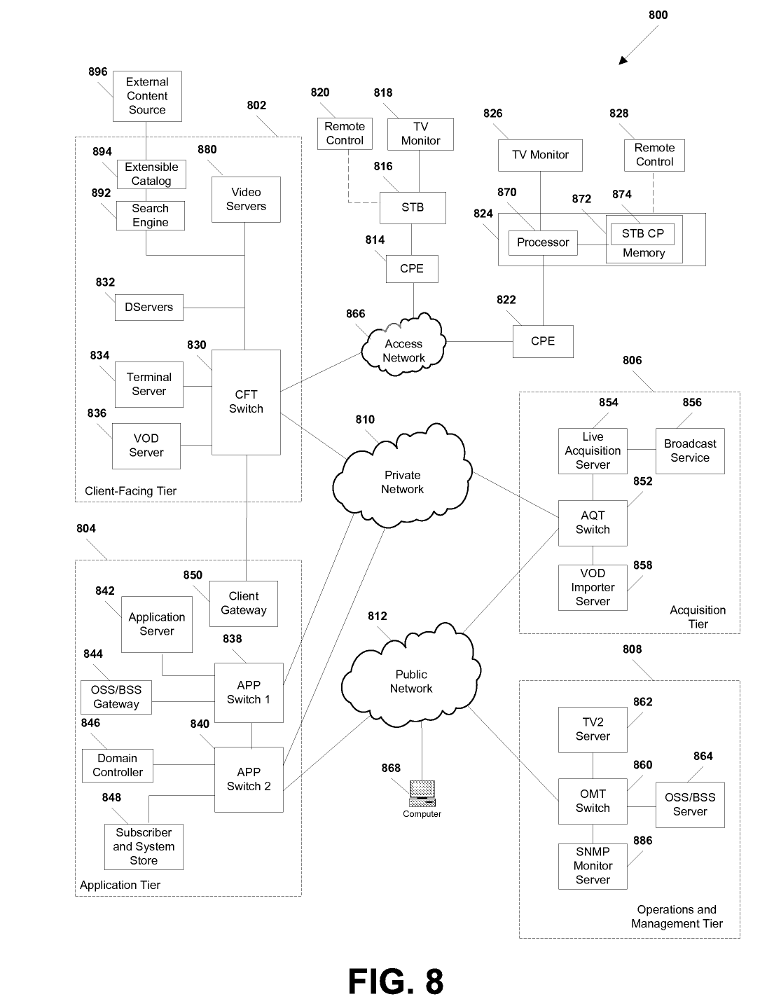

Referring to FIG. 8, an illustrative embodiment of an Internet Protocol Television (IPTV) system that may be used to share private media content is illustrated and is generally designated 800. For example, the IPTV system 800 may be the private media content delivery network 204 of FIG. 2, the private media content delivery network 304 of FIG. 2, or the private media content delivery network 406 of FIG. 4. As shown, the system 800 can include a client facing tier 802, an application tier 804, an acquisition tier 806, and an operations and management tier 808. Each tier 802, 804, 806, 808 is coupled to a private network 810; to a public network 812, such as the Internet; or to both the private network 810 and the public network 812. For example, the client-facing tier 802 can be coupled to the private network 810. Further, the application tier 804 can be coupled to the private network 810 and to the public network 812. The acquisition tier 806 can also be coupled to the private network 810 and to the public network 812. Additionally, the operations and management tier 808 can be coupled to the public network 812.

As illustrated in FIG. 8, the various tiers 802, 804, 806, 808 communicate with each other via the private network 810 and the public network 812. For instance, the client-facing tier 802 can communicate with the application tier 804 and the acquisition tier 806 via the private network 810. The application tier 804 can communicate with the acquisition tier 806 via the private network 810. Further, the application tier 804 can communicate with the acquisition tier 806 and the operations and management tier 808 via the public network 812. Moreover, the acquisition tier 806 can communicate with the operations and management tier 808 via the public network 812. In a particular embodiment, elements of the application tier 804, including, but not limited to, a client gateway 850, can communicate directly with the client-facing tier 802.

The client-facing tier 802 can communicate with user equipment via an access network 866, such as an Internet Protocol Television (IPTV) access network. In an illustrative embodiment, customer premises equipment (CPE) 814, 822 can be coupled to a local switch, router, or other device of the access network 866. The client-facing tier 802 can communicate with a first representative set-top box device 816 at a first customer premise via the first CPE 814 and with a second representative set-top box device 824 at a second customer premise via the second CPE 822. The CPE 814, 822 can include routers, local area network devices, modems, such as digital subscriber line (DSL) modems, any other suitable devices for facilitating communication between a set-top box device and the access network 866, or any combination thereof.

In a particular embodiment, the client-facing tier 802 can be coupled to the CPE 814, 822 via fiber optic cables. Alternatively, the CPE 814, 822 can be digital subscriber line (DSL) modems that are coupled to one or more network nodes via twisted pairs, and the client-facing tier 802 can be coupled to the network nodes via fiber-optic cables. Each set-top box device 816, 824 can process data received via the access network 866, via an IPTV software platform, such as Microsoft® TV IPTV Edition.

The first set-top box device 816 can be coupled to a first external display device, such as a first television monitor 818, and the second set-top box device 824 can be coupled to a second external display device, such as a second television monitor 826. Moreover, the first set-top box device 816 can communicate with a first remote control 820, and the second set-top box device 824 can communicate with a second remote control 828. The set-top box devices 816, 824 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 816, 824 can receive data, video, or any combination thereof, from the client-facing tier 802 via the access network 866 and render or display the data, video, or any combination thereof, at the display device 818, 826 to which it is coupled. In an illustrative embodiment, the set-top box devices 816, 824 can include tuners that receive and decode television programming signals or packet streams for transmission to the display devices 818, 826. Further, the set-top box devices 816, 824 can include a STB processor 870 and a STB memory device 872 that is accessible to the STB processor 870. In one embodiment, a computer program, such as the STB computer program 874, can be embedded within the STB memory device 872. In another illustrative embodiment, a user computing device 884, such as a personal computer, laptop or local server, can be coupled to a set-top box device, such as the second representative set-top box device 824, for example, via a universal serial bus (USB) connection or other connection.

In an illustrative embodiment, the client-facing tier 802 can include a client-facing tier (CFT) switch 830 that manages communication between the client-facing tier 802 and the access network 866 and between the client-facing tier 802 and the private network 810. As illustrated, the CFT switch 830 is coupled to one or more data servers, such as D-servers 832, that store, format, encode, replicate, or otherwise manipulate or prepare video content for communication from the client-facing tier 802 to the set-top box devices 816, 824. The CFT switch 830 can also be coupled to a terminal server 834 that provides terminal devices with a connection point to the private network 810. In a particular embodiment, the CFT switch 830 can be coupled to a video-on-demand (VOD) server 836 that stores or provides VOD content imported by the IPTV system 800.

Further, the CFT switch 830 is coupled to one or more video servers 880 that receive video content and transmit the content to the set-top boxes 816, 824 via the access network 866. In a particular embodiment, the CFT switch 830 can be coupled to one or more publication servers 882 that facilitate the formation of groups that share private content and the inclusion of indicators of such private content with video content received by users in a group.

The CFT switch 830 is coupled to a search engine 892. The search engine 892 is coupled to an extensible catalog 894. The extensible catalog 894 is coupled to an external content source 896. The extensible catalog 894 may be an example of the extensible catalog 104 of FIG. 1 or the extensible catalog 310 of FIG. 3.

In an illustrative embodiment, the client-facing tier 802 can communicate with a large number of set-top boxes, such as the representative set-top boxes 816, 824 over a wide geographic area, such as a regional area, a metropolitan area, a viewing area, a designated market area or any other suitable geographic area, market area, or subscriber or customer group that can be supported by networking the client-facing tier 802 to numerous set-top box devices. In a particular embodiment, the CFT switch 830, or any portion thereof, can include a multicast router or switch that feeds one or more video streams from a video server to multiple set-top box devices.

As illustrated in FIG. 8, the application tier 804 can communicate with both the private network 810 and the public network 812. The application tier 804 can include a first application tier (APP) switch 838 and a second APP switch 840. In a particular embodiment, the first APP switch 838 can be coupled to the second APP switch 840. The first APP switch 838 can be coupled to an application server 842 and to an OSS/BSS gateway 844. In a particular embodiment, the application server 842 can provide applications to the set-top box devices 816, 824 via the access network 866, which enable the set-top box devices 816, 824 to provide functions, such as display, messaging, processing of IPTV data and VOD material, etc. In a particular embodiment, the OSS/BSS gateway 844 includes operation systems and support (OSS) data, as well as billing systems and support (BSS) data. In one embodiment, the OSS/BSS gateway 844 can provide or restrict access to an OSS/BSS server 864 that stores operations and billing systems data.

The second APP switch 840 can be coupled to a domain controller 846 that provides Internet access, for example, to users at their computers 868 via the public network 812. For example, the domain controller 846 can provide remote Internet access to IPTV account information, e-mail, personalized Internet services, or other online services via the public network 812. In addition, the second APP switch 840 can be coupled to a subscriber and system store 848 that includes account information, such as account information that is associated with users who access the IPTV system 800 via the private network 810 or the public network 812. In an illustrative embodiment, the subscriber and system store 848 can store subscriber or customer data and create subscriber or customer profiles that are associated with IP addresses of corresponding set-top box devices 816, 824.

In a particular embodiment, the application tier 804 can include a client gateway 850 that communicates data directly to the client-facing tier 802. In this embodiment, the client gateway 850 can be coupled directly to the CFT switch 830. The client gateway 850 can provide user access to the private network 810 and the tiers coupled thereto. In an illustrative embodiment, the set-top box devices 816, 824 can access the IPTV system 800 via the access network 866, using information received from the client gateway 850. User devices can access the client gateway 850 via the access network 866, and the client gateway 850 can allow such devices to access the private network 810 once the devices are authenticated or verified. Similarly, the client gateway 850 can prevent unauthorized devices, such as hacker computers or stolen set-top box devices from accessing the private network 810, by denying access to these devices beyond the access network 866.

For example, when the first representative set-top box device 816 accesses the client-facing tier 802 via the access network 866, the client gateway 850 can verify subscriber information by communicating with the subscriber and system store 848 via the private network 810. Further, the client gateway 850 can verify billing information and status by communicating with the OSS/BSS gateway 844 via the private network 810. In one embodiment, the OSS/BSS gateway 844 can transmit a query via the public network 812 to the OSS/BSS server 864. After the client gateway 850 confirms subscriber and/or billing information, the client gateway 850 can allow the set-top box device 816 to access IPTV content and VOD content at the client-facing tier 802. If the client gateway 850 cannot verify subscriber information for the set-top box device 816, e.g., because it is connected to an unauthorized twisted pair, the client gateway 850 can block transmissions to and from the set-top box device 816 beyond the access network 866.

As indicated in FIG. 8, the acquisition tier 806 includes an acquisition tier (AQT) switch 852 that communicates with the private network 810. The AQT switch 852 can also communicate with the operations and management tier 808 via the public network 812. In a particular embodiment, the AQT switch 852 can be coupled to a live acquisition server 854 that receives or acquires television content, movie content, advertisement content, other video content, or any combination thereof, from a broadcast service 856, such as a satellite acquisition system or satellite head-end office. In a particular embodiment, the live acquisition server 854 can transmit content to the AQT switch 852, and the AQT switch 852 can transmit the content to the CFT switch 830 via the private network 810.

In an illustrative embodiment, content can be transmitted to the D-servers 832, where it can be encoded, formatted, stored, replicated, or otherwise manipulated and prepared for communication from the video server(s) 880 to the set-top box devices 816, 824. The CFT switch 830 can receive content from the video server(s) 880 and communicate the content to the CPE 814, 822 via the access network 866. The set-top box devices 816, 824 can receive the content via the CPE 814, 822, and can transmit the content to the television monitors 818, 826. In an illustrative embodiment, video or audio portions of the content can be streamed to the set-top box devices 816, 824.

Further, the AQT switch 852 can be coupled to a video-on-demand importer server 858 that receives and stores television or movie content received at the acquisition tier 806 and communicates the stored content to the VOD server 836 at the client-facing tier 802 via the private network 81 0. Additionally, at the acquisition tier 806, the video-on-demand (VOD) importer server 858 can receive content from one or more VOD sources outside the IPTV system 800, such as movie studios and programmers of non-live content. The VOD importer server 858 can transmit the VOD content to the AQT switch 852, and the AQT switch 852, in turn, can communicate the material to the CFT switch 830 via the private network 810. The VOD content can be stored at one or more servers, such as the VOD server 836.

When users issue requests for VOD content via the set-top box devices 816, 824, the requests can be transmitted over the access network 866 to the VOD server 836, via the CFT switch 830. Upon receiving such requests, the VOD server 836 can retrieve the requested VOD content and transmit the content to the set-top box devices 816,124 across the access network 866, via the CFT switch 830. The set-top box devices 816, 824 can transmit the VOD content to the television monitors 818, 826. In an illustrative embodiment, video or audio portions of VOD content can be streamed to the set-top box devices 816, 824.

FIG. 8 further illustrates that the operations and management tier 808 can include an operations and management tier (OMT) switch 860 that conducts communication between the operations and management tier 808 and the public network 812. In the embodiment illustrated by FIG. 8, the OMT switch 860 is coupled to a TV2 server 862. Additionally, the OMT switch 860 can be coupled to an OSS/BSS server 864 and to a simple network management protocol (SNMP) monitor 886 that monitors network devices within or coupled to the IPTV system 800. In a particular embodiment, the OMT switch 860 can communicate with the AQT switch 852 via the public network 812.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

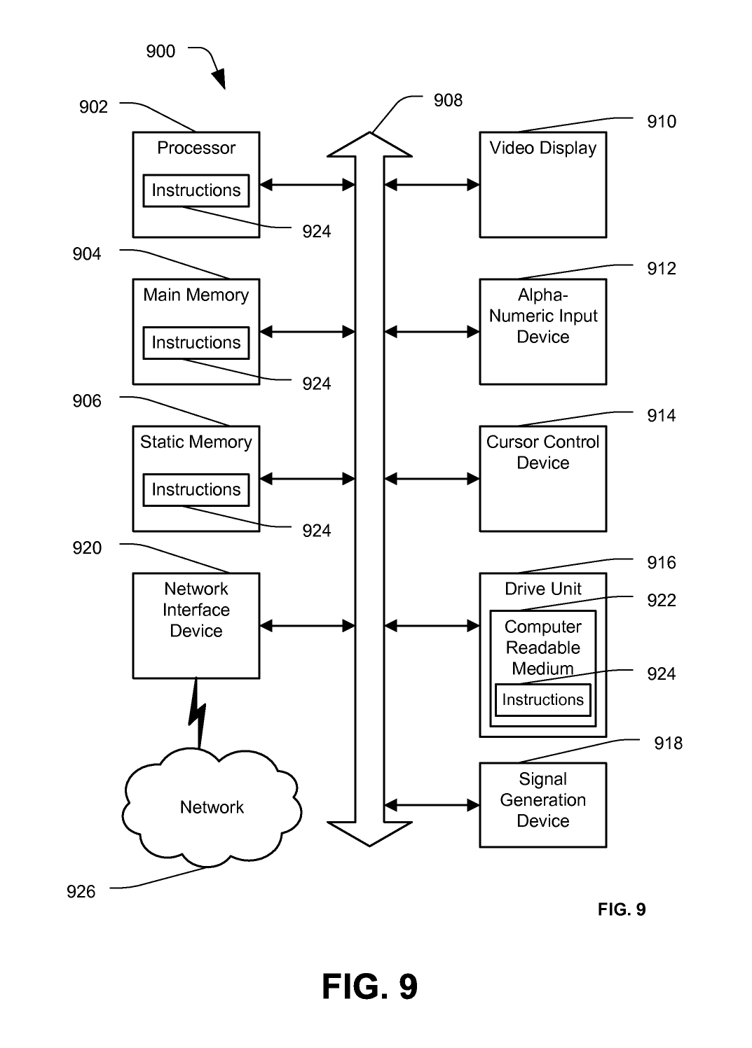

Referring to FIG. 9, an illustrative embodiment of a general computer system is shown and is designated 900. The computer system 900 includes a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices.

In a networked deployment, the computer system may operate in the capacity of a set-top box device, a server, or a mobile computing device, such as the search engine 120 of FIG. 1, the devices 102, 108, 110, and 112 of FIG. 1, the platforms 210, 240, and 222 of FIG. 2, the device 202 of FIG. 2, the set-top box device 302 of FIG. 3, the storefront server 308 of FIG. 3, the platforms 336 and 338 of FIG. 3, and the devices 402 and 404 of FIG. 4. The computer system 900 can also be implemented as or incorporated into various devices, such as a personal computer (PC), a tablet PC, a personal digital assistant (PDA), a mobile device, a palmtop computer, a laptop computer, a desktop computer, a communications device, a web appliance, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include or be coupled to a video display unit 910, such as a liquid crystal display (LCD), an organic light emitting diode (OLED), a flat panel display, a cathode ray tube (CRT) display, a solid-state display, or a projection display. Additionally, the computer system 900 may include an input device 912, such as a keyboard, a remote control device, and a cursor control device 914, such as a mouse. The computer system 900 can also include a disk drive unit 916, a signal generation device 918, such as a speaker or remote control device, and a network interface device 920. The network interface device 920 may be coupled to other devices (not shown) via a network 926.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/item distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered equivalent to a tangible storage medium. Accordingly, the disclosure is considered to include any one or more of a computer-readable storage medium and other equivalents and successor media, in which data or instructions may be stored.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories.

Although the present specification describes components and functions that may be implemented in particular embodiments with reference to particular standards and protocols, the invention is not limited to such standards and protocols. For example, standards for Internet, other packet switched network transmission (e.g. TCP/IP, UDP/IP, HTML, and HTTP) and standards for viewing media content (e.g. MPEG, SMPTE, and H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer implemented method, comprising:
receiving a search query at a computing device of a private media delivery network;
after receiving the search query, performing a first search with respect to first content available from a first platform within the private media delivery network and performing a second search with respect to second content available from a second platform that is external to the private media delivery network; and
sending search results for display at a display device, the search results based on the first search and based on the second search.

2. The computer implemented method of claim 1, wherein the second content includes electronically downloadable content.

3. The computer implemented method of claim 2, wherein the electronically downloadable content includes a ringtone capable of being downloaded to a mobile phone device.

4. The computer implemented method of claim 2, wherein the electronically downloadable content includes a compressed audio file capable of being downloaded to an electronic device that includes a music player.

5. The computer implemented method of claim 2, wherein the electronically downloadable content includes a compressed video file capable of being downloaded to a video player.

6. The computer implemented method of claim 1, wherein the second content includes information descriptive of tangible products available for purchase.

7. The computer implemented method of claim 6, further comprising receiving a request to purchase at least one of the tangible products.

8. The computer implemented method of claim 7, further comprising:
processing the request to purchase the at least one tangible product; and
sending an order identifying the at least on tangible product to an order fulfillment system.

9. The computer implemented method of claim 1, wherein the second platform includes an electronic commerce portal.

10. The computer implemented method of claim 1, further comprising adding a third platform that is external to the private media delivery network, the third platform searchable via the search interface.

11. The computer implemented method of claim 14, further comprising performing a search with respect to third content available from the third platform.

12. A set-top box device including a computer-readable storage medium comprising operational instructions that, when executed by a processor, cause the set-top box device to:
receive a search query from a remote control device;
send the search query from the set-top box device to a storefront server of a private media delivery network, the storefront server capable of searching an extensible catalog, wherein the extensible catalog is extensible by adding a new catalog that is searchable via the search query; and
receive search results from the storefront server, the search results comprising information identifying content from a plurality of content sources of the extensible catalog, wherein at least some of the information identifying the content is available from a content source external to the private media content delivery network.

13. The set-top box device of claim 12, wherein the extensible catalog includes first content available from a first platform within the private media content delivery network and second content available from a second platform that is external to the private media content delivery network, wherein the first content includes electronically downloadable content, and wherein the second content includes tangible products available for purchase.

14. The set-top box device of claim 12, further comprising operational instructions, that when executed by the set-top box device, cause the set-top box device to:
display an alphanumeric input screen to facilitate input of the search query via selections received from the remote control device; and
receive an asset type selection from a set of displayed asset types and wherein the search results comprise assets from the extensible catalog having the selected asset type.

15. A computer system comprising:
a search engine interface to receive a search request and to output search results via a private media content delivery network;
a searchable database responsive to the search engine interface, the searchable database including memory to store a plurality of catalogs, each catalog including information identifying downloadable items and information identifying physical items available for purchase, wherein the searchable database is searchable in response to receiving the search request to provide the search results, wherein at least one catalog of the plurality of catalogs is eternal to the private media content delivery network; and
catalog extension logic to selectively extend the catalog by adding a catalog to the searchable database.

16. The computer system of claim 15, further comprising a catalog update interface to receive a new catalog of items available for purchase from a third party and to add the new catalog into the searchable database via the catalog extension logic, wherein the third party is different from a provider of the search engine interface.

17. The computer system of claim 16, wherein, before receiving the new catalog the catalog update interface is operable to authenticate a request from the third party to add the new catalog to the searchable database.

18. The computer system of claim 15, wherein at least one of the downloadable items is available for purchase at a first device and downloadable by a second device.

19. The computer system of claim 18, wherein the second device is a wireless computing device and wherein the at least one downloadable item is downloadable via an Internet Protocol Television (IPTV) network.

20. The computer system of claim 15, further comprising a physical fulfillment interface to receive an order to purchase at least one physical item and to send the order to a fulfillment system.
